(19) United States
(12) Patent Application Publication
(10) Pub. No.: US 2015/0044899 A1
(43) Pub. Date: Feb. 12, 2015

(54) ELECTRICAL CONNECTOR WITH ADDITIONAL EXTERIOR SHELL

(71) Applicant: HON HAI PRECISION INDUSTRY CO., LTD., New Taipei (TW)

(72) Inventors: DING-BING FAN, Kunshan (CN); JI-CHAO WANG, Kunshan (CN); GUO-HUA ZHANG, Kunshan (CN); QI-SHENG ZHENG, Kunshan (CN)

(21) Appl. No.: 14/452,534

(22) Filed: Aug. 6, 2014

(30) Foreign Application Priority Data
Aug. 6, 2013 (CN) 2013204752268

(51) Int. Cl. H01R 24/62; H01R 13/639; H01R 13/50

(52) U.S. Cl. CPC H01R 24/62; H01R 13/50; H01R 13/639
USPC 439/353; 439/676

(57) ABSTRACT

An electrical connector comprises an insulative housing, a plurality of contacts retained in the insulative housing, an inner shell covering the insulative housing and an exterior shell stacked over the inner shell. The insulative housing has a base portion and a tongue portion extending forwardly. The tongue portion has a mating face with a plurality of receiving slots recessed therein. The contacts have a plurality of contact portions received in the receiving slots. The inner shell has a mating chamber surrounding the tongue portion and a top wall with a through hole; The exterior shell has a main plate overlapping on the top wall of the inner shell. The main plate has an opening extending through thereof and a beam connecting with at least one edge of the opening. The beam has a resilient portion protruding into the mating chamber through the through hole.

### BACKGROUND OF THE INVENTION

1. Field

The present invention generally relates to an electrical connector and more particularly to an electrical connector having an inner shell and an exterior shell stacked over the inner shell.

2. Description of Related Art

China patent No. CN201956511U, published on Aug. 31, 2011, discloses such an electrical connector which includes an insulative housing defining a base portion and a tongue portion extending forwardly, a plurality of contacts retained in the insulative housing, an inner shell surrounding the insulative housing and forming a mating chamber around the tongue portion, and an exterior shell. The inner shell has a top wall with two spring taps extending into the mating chamber. The exterior shell has two cantilevered arms tore from a main plate thereof. The cantilevered arms are set above the spring taps respectively. However, the exterior shell can strengthen the electrical connector a strong strength while the additional cantilevered arm may cause a weak insertion and extraction force.

It is thus desired to provide an improved electrical connector.

### SUMMARY OF THE INVENTION

According to one aspect of the present invention provides an electrical connector comprising an insulative housing, a plurality of contacts retained in the insulative housing, an inner shell covering the insulative housing and an exterior shell stacked over the inner shell. The insulative housing has a base portion and a tongue portion extending forwardly. The tongue portion has a mating face with a plurality of receiving slots recessed therein; The contacts have a plurality of contact portions received in the receiving slots; The inner shell has a mating chamber surrounding the tongue portion and a top wall with a through hole extending through therein; The exterior shell has a main plate lapped on the top wall of the inner shell. The main plate has an opening extending through therein and a beam connecting with at least one inner wall of the opening. The beam has a resilient portion protruding into the mating chamber through the through hole.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector according to a first embodiment of the present invention;

FIG. 2 is similar view of FIG. 1, but taken from another view;

FIG. 3 is a partly exploded perspective view of the electrical connector;

FIG. 4 is an exploded perspective view of the electrical connector;

FIG. 5 is a similar view of FIG. 4, but taken from another view;

FIG. 6 is a partly assembled perspective view of the electrical connector with its shell removed; and

FIG. 7 is a top plan view of the electrical connector.

### DETAILED DESCRIPTION OF THE INVENTION

Reference will now be made to the drawing figures to describe the preferred embodiment of the present invention in detail.

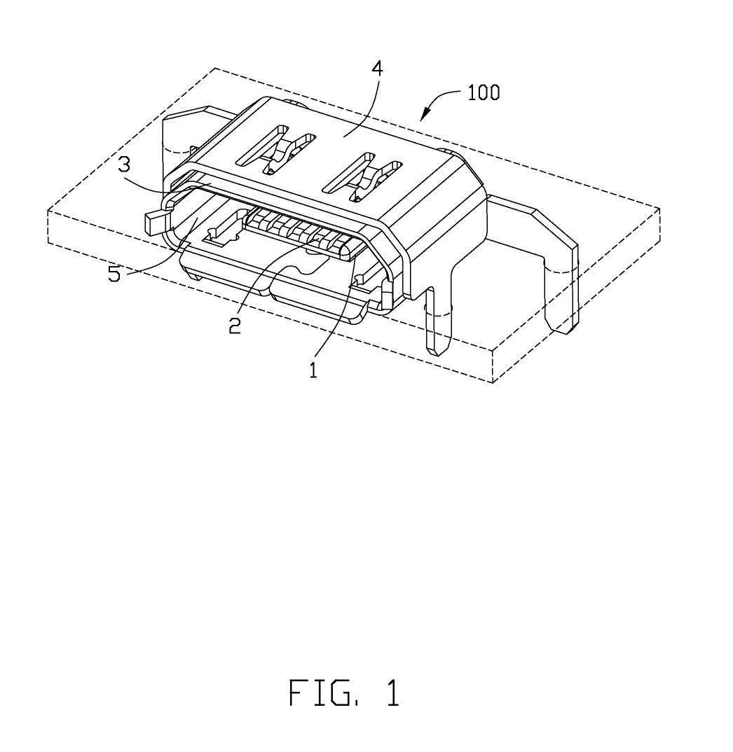

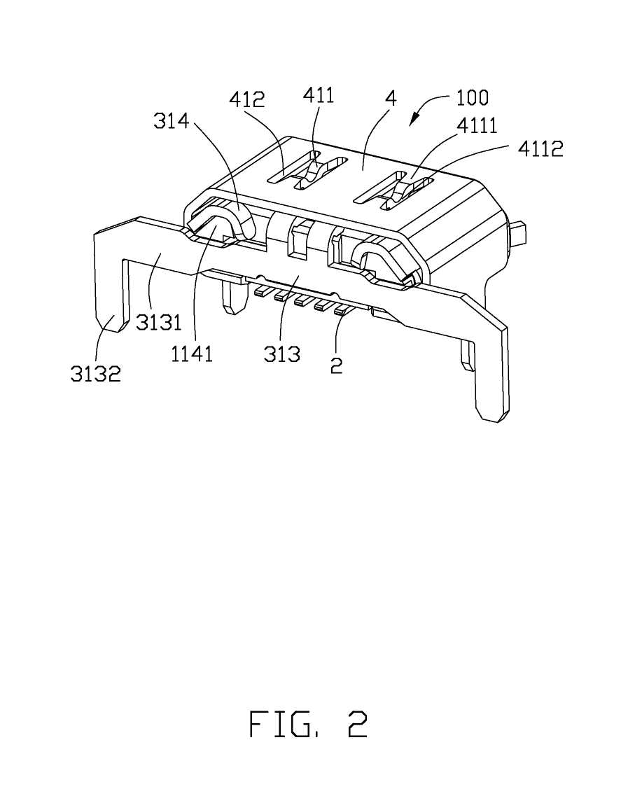

Referring to FIGS. 1-3, an electrical connector 100 according to a prefer embodiment of the present invention is disclosed. The electrical connector 100 of this embodiment is a reverse Micro USB receptacle, the electrical connector 100 includes an insulative housing 1, a plurality of contacts 2 retained in the insulative housing 1, an inner shell 3 enclosing the insulative housing and forming a mating chamber 5 therebetween and an exterior shell 4 fixed in an outside of a top side of the inner shell 3.

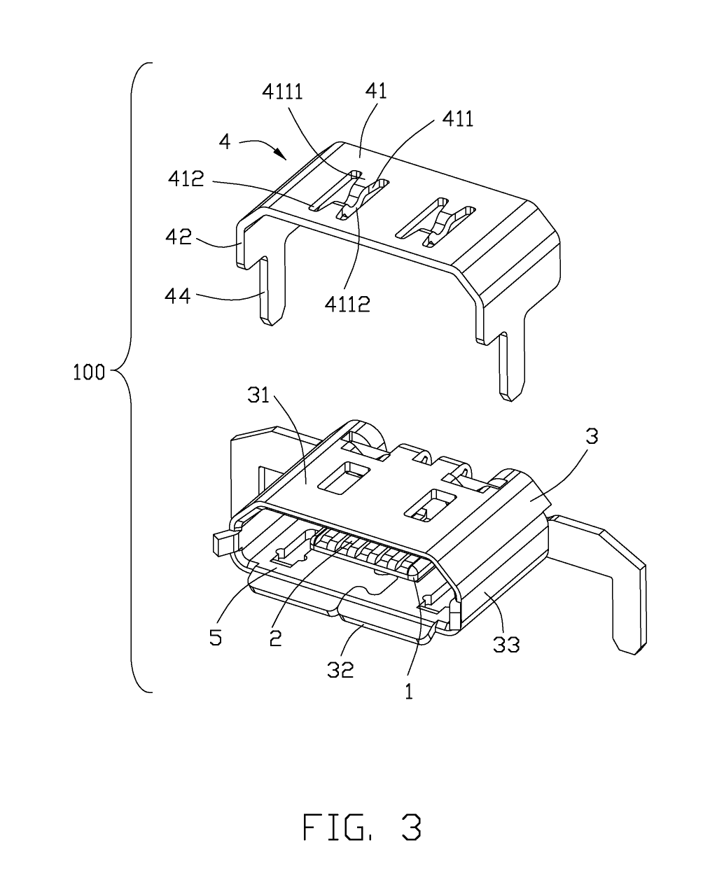

Please referring to FIGS. 3-5, the insulative housing 1 includes a base portion 11 and a tongue portion 12 extending forwardly from a front face 110 of the base portion 11. The tongue portion 12 defines a mating face 121, a supporting face 122 opposite to the mating face 121 and a plurality of receiving slots 1211 recessed on the mating face 121. The base portion 11 has a top face 111, a bottom face 112 opposite to the top face 111, two side faces 113 vertically connecting with two sides of the bottom faces 112 respectively, a pair of inclined faces 115 respectively connecting the two side faces 113 and two sides of the top surface 111 and a rear face 114 opposite to the front face 110. The base portion 11 further has first locking slots 1111 depressed on a front side of the top face 111 and second locking slots 1112 depressed on a rear side of the top face 111. The first locking slots 1111 extend through the front face 110, and the second locking slots 1112 extend through the rear face 114. The base portion 11 further includes a pair of protrusions 1141 protruding backwardly from the rear face 114 and connecting with the inclined faces 115 respectively.

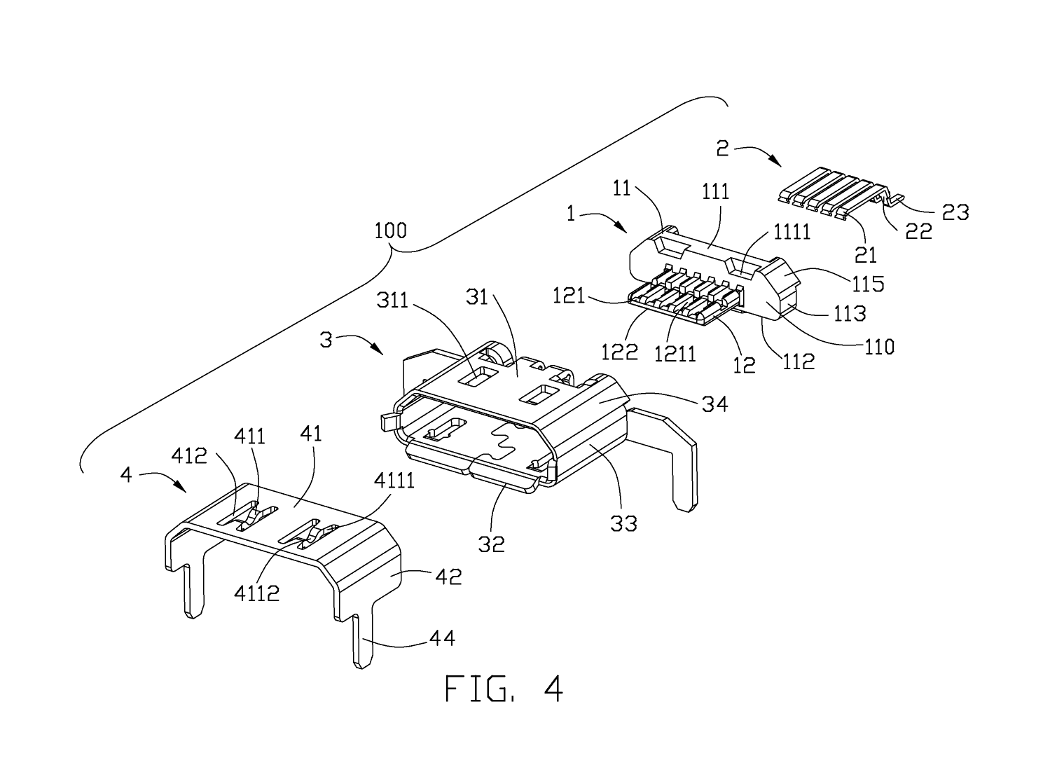

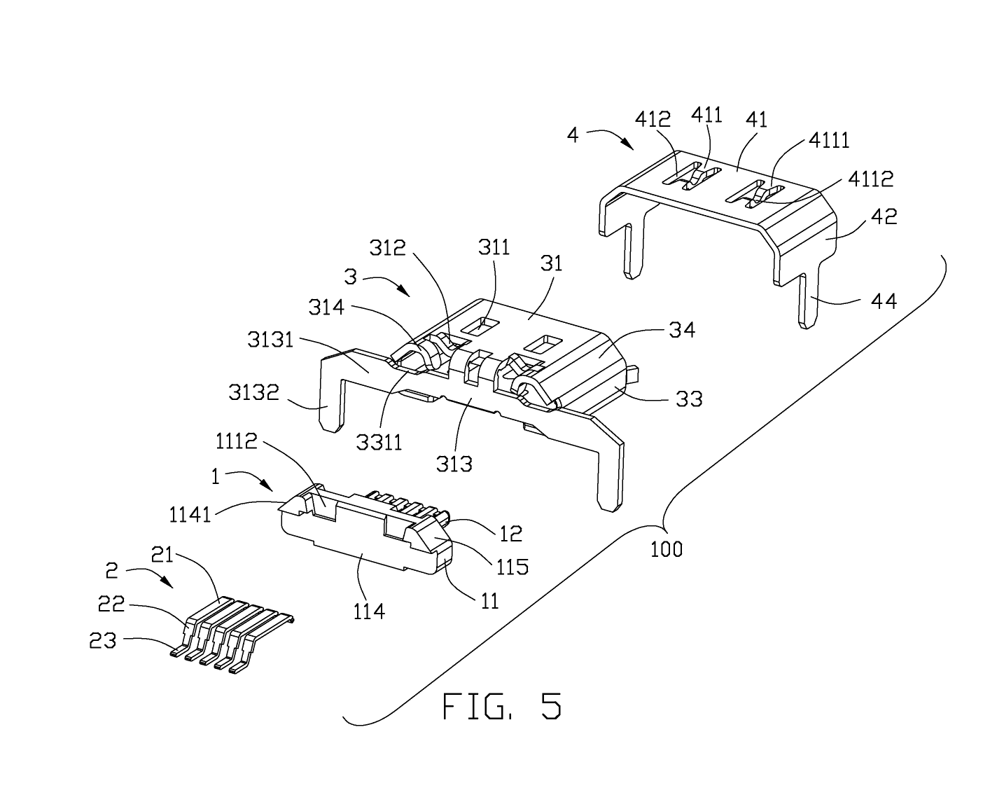

Referring to FIGS. 4-5, the inner shell 3 defines a receiving chamber 5 surrounding the tongue portion 12. The inner shell 3 has a top wall 31 facing the mating face 121, a bottom wall 32 opposite to the top wall 31, two side walls 33 covering the two side faces 113 and two inclined walls 34 covering over the inclined face 115 of the base portion 11. The top wall 31 has a pair of rectangle through holes 311 at a middle of the top wall 31, a pair of engaging portions 312 tore downwardly at an rear side of the top wall 31, another pair of locking portion 314 located at two sides of a rear edge of the top wall 31 and a rear wall 313 bent front a middle of the rear end of the top wall 31 to support the rear face 114 of the base portion 11. The through holes 311 extend through the top wall 31 along an upper-to-down direction. The engaging portions 312 extend downwardly into the first locking slots 1111 and engage with inner walls of the first locking slots 1111 to position the base portion 11 and the inner shell 3 together. The locking portion 314 bents from an end of the incline wall 34 and extends into the second locking slot 1112 to position the base portion 11 in the inner shell 3. The rear wall 313 has an elongate body 3131 and two soldering legs 3132 extending downwardly from two side edges thereof. The elongate body 3131 has two limiting edges 3311 supporting the two protrusions 1141 to give a supporting force.

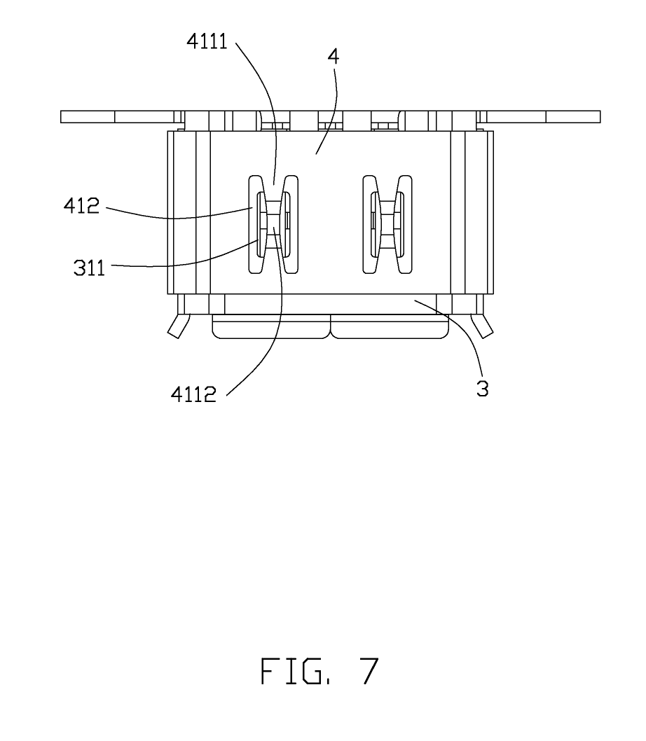

The exterior shell 4 has a main plate 41 overlapping the top wall 31 of the inner shell 3, two side plates 42 connecting with the main plate 41 and stacked over the incline walls 34 and side walls 33, and a retaining leg 44 extending downwardly from each of the side plate 42 to solder on a print circuit board. The main body 41 has two opening 412 covering over the two through holes 311 and a bridge beam 411 connecting two side inner walls of the two side ends of the opening 412 along an front-to-back direction. The bridge beam 411 has a resilient portion 4112 protruding into the mating chamber 5 through the through hole 311, two supporting arms 4111 connecting with two sides of the resilient portions 4112 and the two inner walls of the opening 412. The bridge beam 41 extends along the front-to-back direction. The supporting arm 4111 is mostly supported by the top wall 31 around the through holes 311 along an upper-to-down direction. Please referring to FIG. 7, the opening 412 is larger than that of the through hole 311 not only their length but also their width. So, the two supporting arms 4111 are supported by the top wall 31 while the resilient portions 4112 protrud into the mating chamber 5.

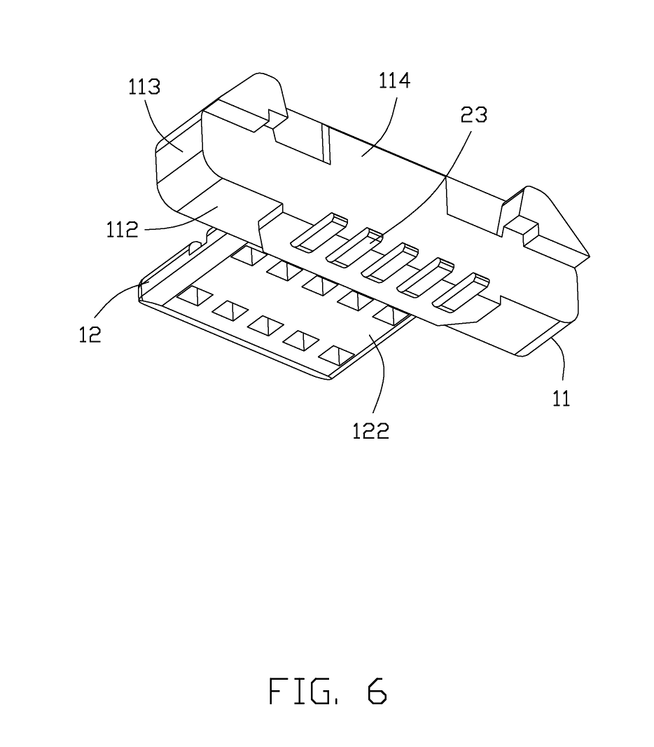

As shown in FIGS. 1-2 and 6, the contacts 2 include five terminals insert-molded in the insulative housing 1. Each contact 2 has a contact portion 21 received in the receiving slot 1211, a positioning portion 22 insert-molded in the base portion 11 and a soldering portion 23 extending beyond the bottom face 112 and extending backwardly and beyond the rear face 114. The contact portion 21 extends forwardly from a front end of the positioning portion 22, and the soldering portion 23 extend backwardly from rear end of the positioning portion 23 and align linearly in the bottom face 112. The soldering portion 23 is parallel to the contact portion 21.

Referring to FIGS. 1-7, the electric connector 100 has the inner shell 3 and the exterior shell 4 coordinated together to give a stronger supporting power when a plug inserting into or separating away from the mating chamber 5. At the same time, if the bridge beam 411 is damaged, the user can only change a new exterior shell to give a stronger clamping force rather than replace the whole electrical connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a base portion and a tongue portion extending forwardly from a front face of the base portion, the tongue portion having a mating face with a plurality of receiving slots recessed therein;
a plurality of contacts retained in the insulative housing with their contact portions received in the receiving slots;
an inner shell forming a mating chamber surrounding the tongue portion and having a top wall with a through hole extending along an upper-to-down direction; and
an exterior shell having a main plate overlapping on the top wall of the inner shell, the main plate having an opening extending therethrough and a beam connecting with at least one edge of the opening; wherein
the beam has a resilient portion protruding into the mating chamber through the through hole of the inner shell.

2. The electrical connector as claimed in claim 1, wherein the beam further comprises a supporting arm connecting with the resilient portion and the at least one edge of the opening, the supporting arm is supported by the top wall around the through hole but exposed in the opening.

3. The electrical connector as claimed in claim 1, wherein a length of the opening is longer than that of the through hole along a front-to-back direction, and the beam is partly located over the through hole and partly protrudes into the through hole.

4. The electrical connector as claimed in claim 1, wherein the beam is a bridge beam.

5. The electrical connector as claimed in claim 4, wherein the bridge beam has two supporting arms connecting with two sides of the inner edges of the opening along the front-to back direction, and the resilient portion connects between the two supporting arms.

6. The electrical connector as claimed in claim 5, wherein the opening is larger than the through hole, and the supporting arms are mostly supported by the top wall exposed on the opening.

7. The electrical connector as claimed in claim 6, wherein a length or a width of the opening is larger than that of the through hole along the front-to-back direction or along a left-to-right direction.

8. The electrical connector as claimed in claim 1, wherein the exterior shell further comprises two side plates connecting with the main plate and stacked over the inner shell, and two retaining legs extending downwardly from the side plates.

9. The electrical connector as claimed in claim 8, wherein the inner shell has an rear wall located at a rear side of the insulative housing with a pair of soldering legs located at the rear side of the electrical connector, the retaining legs located at a front side of the soldering legs.

10. An electrical connector comprising:
an insulative housing having a base portion and a tongue portion extending forwardly from a front face of the base portion;
a plurality of contacts retained to the insulative housing, the contacts having a plurality of contacting portions disposed on a mating face of the tongue portion;
an inner shell surrounding around the insulative housing and forming a mating chamber between the inner shell and the tongue portion; and
an exterior shell covering the inner shell along an upper-to-down direction, the exterior shell having a pair of retaining legs extending downwardly and located outside of two sides of the inner shell;
wherein the inner shell has a top wall with a through hole, the exterior shell has a main plate located above the top wall and defining a opening, the opening extends though the main plate and is larger than that of the through hole of the top wall, the exterior shell further has a beam in the opening and protrudes in to the through hole.

11. The electrical connector as claimed in claim 10, wherein a length of the opening along a front-to-back direction is longer than a width of the opening along a left-to-sight direction.

12. The electrical connector as claimed in claim 11, wherein the beam comprises a supporting portion located over the top wall around the through hole but partly exposed in the opening.

13. An electrical connector comprising:
an insulative housing;
a plurality of contacts disposed in the housing;
an metallic shell including a plurality of walls commonly enclosing the housing and defining a mating chamber which said contacts are exposed in and which communicates with an exterior in a front-to-back direction;
an opening formed in at least one wall of the shell to communicate the mating chamber with the exterior in a transverse direction perpendicular to said front-to-back direction; and
a metallic bracket enclosing at least said wall of the shell in an attached manner and including a mounting leg for mounting to a printed circuit board on which the housing is seated; wherein
said bracket further includes unitarily a spring arm extending into the mating chamber through said opening for retaining a complementary plug which is adapted to be received in said mating chamber.

14. The electrical connector as claimed in claim 13, wherein the shell includes a vertical rear plate located behind the housing with a mounting leg for mounting to the printed circuit board.

15. The electrical connector as claimed in claim 14, wherein the mounting leg of the shell is located on an outer side with regard to the mounting leg of the bracket in a lateral direction.

16. The electrical connector as claimed in claim 15, wherein the shell further includes a locking portion to prevent rearward movement of the housing relative to the shell, and the vertical rear plate extends under said locking portion to form the mounting leg of the shell.

17. The electrical connector as claimed in claim 13, wherein said spring arm extends in the front-to-back direction with two opposite fixed ends joined with a plate of the bracket.

18. The electrical connector as claimed in claim 17, wherein each of said two opposite fixed ends defines a transversely enlarged tip joined with the plate of the bracket.

19. The electrical connector as claimed in claim 13, wherein said wall of the shell is a top wall, and said transverse direction is essentially a vertical direction.

20. The electrical connector as claimed in claim 13, wherein the spring arm is exposed in the through hole in preloaded manner.
